(19) United States
(12) Patent Application Publication
(10) Pub. No.: US 2007/0133216 A1
(43) Pub. Date: Jun. 14, 2007

(54) Truss fabrication system and method

(76) Inventor: Lowell T. Wood, Germantown, TN (US)

Correspondence Address: Patrick S. Yoder;FLETCHER YODER, P.O. BOX 692289, Houston, TX, 77269-2289, US

(21) Appl. No.: 11/297,584

(22) Filed: Dec. 8, 2005

(51) Int. Cl. B60Q 1/124

(52) U.S. Cl. 362/458

(57) ABSTRACT

In accordance with one embodiment, the present technique relates to a system including a truss fabrication table, a plurality of lights disposed at coordinates on the truss fabrication table, and a light alignable puck disposed on the truss fabrication table. The light alignable puck is configured to align with an illuminated one of the plurality of lights at selected coordinates.

### FIELD OF THE INVENTION

The invention relates generally to truss fabrication and, more particularly, to systems and methods for coordinating or positioning a plurality of truss members into a desired truss configuration.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Trusses are often fabricated on a table using positioning or jigging tools (e.g., pucks), which set boundaries and hold the various truss members in the desired truss configuration. Unfortunately, the existing tables are often inaccurate due to human error, calibration shifts, and so forth. For example, some truss fabrication systems include a table and a separate laser projection system, which is disposed over the table and projects an image onto the table. The image facilitates the assembly of the truss on the table. However, the laser projection system is relatively expensive and difficult to maintain calibration with the table. For example, if the table moves relative to the laser projection system, then the laser projection system will perform inaccurately without recalibration. In another example, a string line is disposed along the table, and the pucks are manually placed at points along the string line. However, the string line approach can result in significant inaccuracies due to human error in the placement of the pucks.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with certain embodiments, the present technique relates to a system including a truss fabrication table, a plurality of lights disposed at coordinates on the truss fabrication table, and a light alignable puck disposed on the truss fabrication table. The light alignable puck is configured to align with an illuminated one of the plurality of lights at selected coordinates.

### DRAWINGS

These and other features, aspects, and advantages of the present invention will become better understood when the following detailed description is read with reference to the accompanying drawings in which like characters represent like parts throughout the drawings, wherein:

FIG. 1 is a top perspective view of an exemplary trust fabrication system 10 including a light array trust fabrication table or gantry table having a light array jigging system in accordance with embodiments of the present technique;

FIG. 2 is a diagrammatical top view of an exemplary embodiment of the truss fabrication system as illustrated in FIG. 1, further illustrating a plurality of control units coupled to a computer system, wherein each control unit is coupled to one of the light array trust fabrication or gantry tables;

FIG. 3 is a partial perspective view of an embodiment of the trust fabrication table as illustrated in FIGS. 1 and 2, further illustrating a light transmitting puck slidingly coupled to a LED lined C-shaped panel in accordance with embodiments of the present technique;

FIG. 4 is a cross-sectional end view of the light transmitting puck and the LED lined C-shaped channel as illustrated in FIG. 3;

FIG. 5 is a cross-sectional side view of the light transmitting puck and the LED lined C-shaped channel as illustrated in FIGS. 3 and 4;

FIG. 6 is an exploded perspective view of the light transmitting puck as illustrated in FIGS. 3-5; and

FIGS. 7 and 8 are diagrammatical top views of a pair of light transmitting pucks disposed in the LED lined C-shaped channel about a portion of the trust assembly in accordance with embodiments of the present technique.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

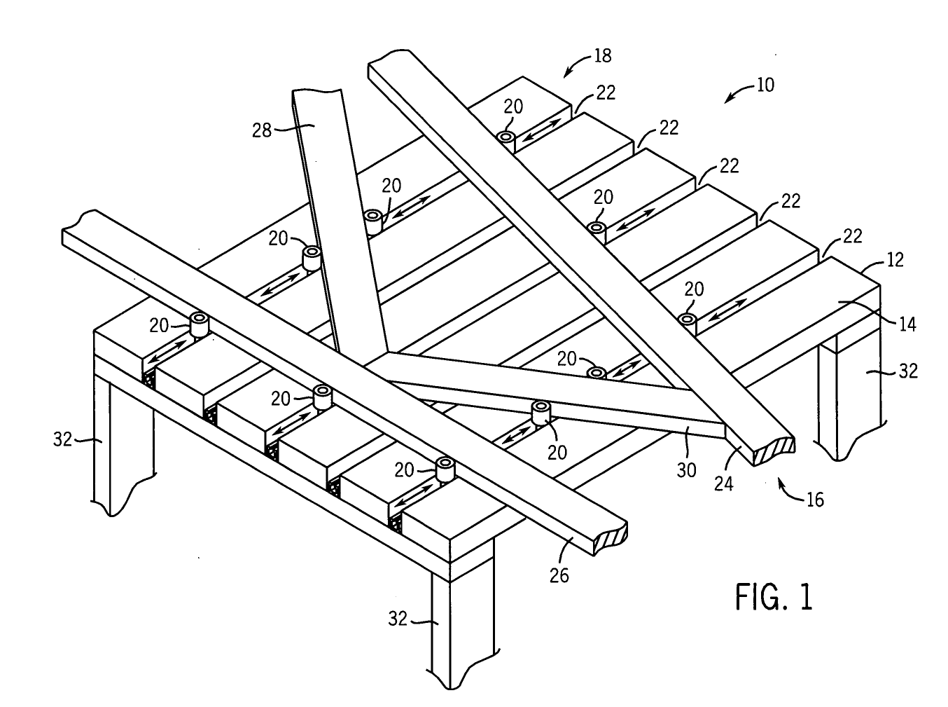

FIG. 1 is a top perspective view of an exemplary truss fabrication system 10 including a light array trust fabrication or gantry table 12 in accordance with embodiments of the present technique. As discussed in further detail below, the light array gantry table 12 includes a plurality of lights, such as light emitting diodes (LEDs), arranged at specific coordinates throughout a table top or trust support 14 to facilitate jigging of a truss assembly 16. The lights may be disposed directly on or within the truss support 14 or, alternatively, the lights may be disposed on one or more structures (e.g., rails, channels, panels, etc.) that can be removably or fixedly coupled (or retrofitted) to a new or pre-existing table 12. Advantageously, the direct integration of these lights with the table 12 reduces the likelihood for calibration shifts, changes, or positional inaccuracies after the initial manufacturing, assembling, or retrofitting of the lights with the table 12. In certain embodiments, the truss fabrication system 10 may include any number of light arrays, rows, columns, matrices, or other coordinate systems having lights, e.g., LEDs, disposed at specific X, Y-coordinates directly on or within the light array gantry table 12.

In the illustrated embodiment, the light array gantry table 12 includes a light array jigging system 18 having a plurality of light alignable or light transmitting pucks 20 disposed removably and slidingly in a plurality of LED lined C-shaped channels 22. In other words, each channel 22 includes an array of LEDs, wherein each LED has a common X-coordinate and a different Y-coordinate. For example, the LEDs in a first channel 22 may have an X-coordinate of 0 and Y-coordinates of 0 plus a predefined Y step amount that accumulates from one LED to another LED successively along the channel 22. The predefined Y step amount may be 1, 2, 3, 4, 5, 6, 7, 8, 9, 10, 11, 12, 13, 14, 15 millimeters, centimeters, inches, tenth of an inch, sixteenth of an inch, or another unit or fractional unit. As discussed below, the LEDs in each channel 22 may be arranged directly or in close proximity side-by-side along the length (Y-direction) of the channel 22, such that the Y-coordinates may be defined largely by the Y dimensions of the individual LEDs in the array. The LEDs in a second channel 22 may have substantially the same Y-coordinates as the first channel 22, while the X-coordinates may be equal to those of the first channel 22 (e.g., X=0) plus a predefined X step amount. For example, the predefined X step amount may be 1, 2, 3, 4, 5, 6, 7, 8, 9, 10, 11, 12, 13, 14, 15 millimeters, centimeters, meters, inches, feet, tenth of an inch, sixteenth of an inch, or another unit or fractional unit. As illustrated in FIG. 1, the channels 22 are spaced apart by the predefined X step, which may correspond to a lengthwise support member, panel, or section of the table 12 between each successive channel 22. Thus, the X-step amount may be defined largely by the amount of structure or support that is desired between each successive channel 22.

As discussed in further detail below, the light array jigging system 18 is configured to illuminate one or more LEDs in the various LED lined C-shaped channels, thereby identifying jig points for the pucks 20. In view of these illuminated LEDs in the LED lined C-shaped channels 22, the light transmitting pucks 20 can be quickly and accurately moved to the appropriate jigging points to define the boundaries and general layout of the desired truss assembly 16. Moreover, as each puck 20 approaches or substantially reaches a centered position over an illuminated LED along a channel 22, the light passes through the light transmitting puck 20 to notify a user that the puck 20 is centered at the desired coordinate. In this manner, the disclosed jigging system 18 substantially reduces or removes human errors and inaccuracies involved with setting the pucks 20 on the table 12. Upon setting the pucks 20 at the desired jigging points, the truss assembly 16 can be accurately oriented and coupled together on the light array gantry table 12.

For example, with the aid of illuminated LEDs in the channels 22, the light transmitting pucks 20 may be moved toward an outer perimeter of a predefined geometrical layout of the truss assembly 16. As illustrated in FIG. 1, the foregoing pucks 20 set the outer boundaries for placement of an upper wooden plank 24 and a lower wooden plank 26. In addition, the illuminated LEDs in the LED lined C-shaped channels 22 may facilitate positioning of the light transmitting pucks 20 at an inner perimeter or web portion of the predefined geometrical layout of the truss assembly 16. Again, as illustrated in FIG. 1, the foregoing pucks 20 set the boundaries for placement of intermediate wooden planks 28 and 30, which form a web between the peripheral upper and lower wooden planks 24 and 26. In the illustrated embodiments, the light array gantry table 12 includes legs 32 to support the table top or truss support 14 and the truss assembly 16 at a desired height for fabrication. The configuration and dimensions of the light array gantry table 12 may depend largely on the type and size of desired truss assembly 16, the number of complementary tables 12, and so forth.

The disclosed system 10 may be used to assemble a variety of truss assemblies 16, which may include residential or commercial roof structures, wall structures, floor structures, and so forth. Moreover, the truss assemblies 16 may include bridge structures, tunnel structures, vehicle framework (e.g., automobiles, locomotives, airplanes, boats, etc.), stationary marine support structures (e.g., oil exploration and retrieval platforms), and so forth. Moreover, the planks 24, 26, 28, and 30 of the truss assembly 16 can include wood, metal, plastic, fiberglass, or other materials, or combinations thereof.

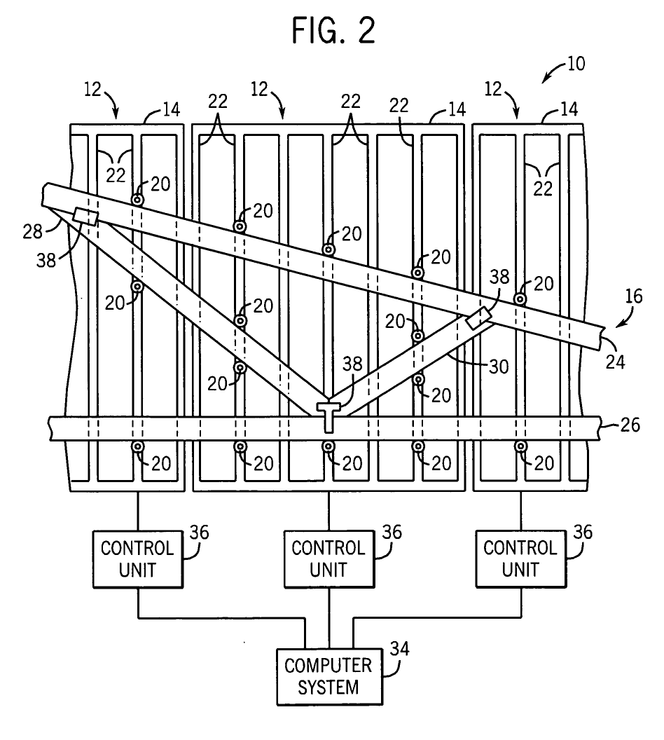

FIG. 2 is a diagrammatical top view of an exemplary embodiment of the trust fabrication system 10 as illustrated in FIG. 1, further illustrating a plurality of the light array gantry tables 12 coupled to a central control system or computer system 34 via control units 36. In certain embodiments, the computer system 34 includes a display, a mouse, a keyboard, a processor, memory, and software. The computer system 34 is configured to facilitate the coordination of jigging points for the light transmitting pucks 20 disposed in the LED lined C-shaped channels 22 on each of the light array gantry tables 12. For example, the computer system 34 may include a computer aided design (CAD) and/or a computer aided manufacture (CAM) system to design the geometrical layout of the planks 24, 26, 28, and 30 of the truss assembly 16 and the corresponding jigging points on the light array gantry table 12.

In operation, the computer system 34 of FIG. 2 may transmit coordinates to each of the control units 36, which in turn transmit signals to illuminate the appropriate LEDs in the LED lined C-shaped channels 22. Upon illumination of these LEDs, the light transmitting pucks 20 may be moved slidingly along the LED lined C-shaped channels 22 until properly positioned (e.g., centered) over the illuminated LEDs. As discussed in further detail below, the light transmitting pucks 20 become illuminated when positioned (e.g., centered) over the illuminated LEDs in the LED lined C-shaped channels 22, thereby ensuring that the light transmitting pucks 20 are accurately positioned (e.g., centered) at the desired jigging points. After positioning all of the light transmitting pucks 20 at the appropriate jigging points on the plurality of light array gantry tables 12, the various wooden planks 24, 26, 28, and 30 of the truss assembly 16 can be secured to one another via suitable fasteners, such as fastening plates 38 as illustrated in FIG. 2. In certain embodiments, the fasteners or plates 38 may be secured to the wooden planks 24, 26, 28, and 30 via a hammer, a roller mechanism, or another form of manual or automatic pressure. Upon completion, the truss assembly 16 may undergo further processing or finishing, such as further fastening operations, wood treatment operations, and so forth.

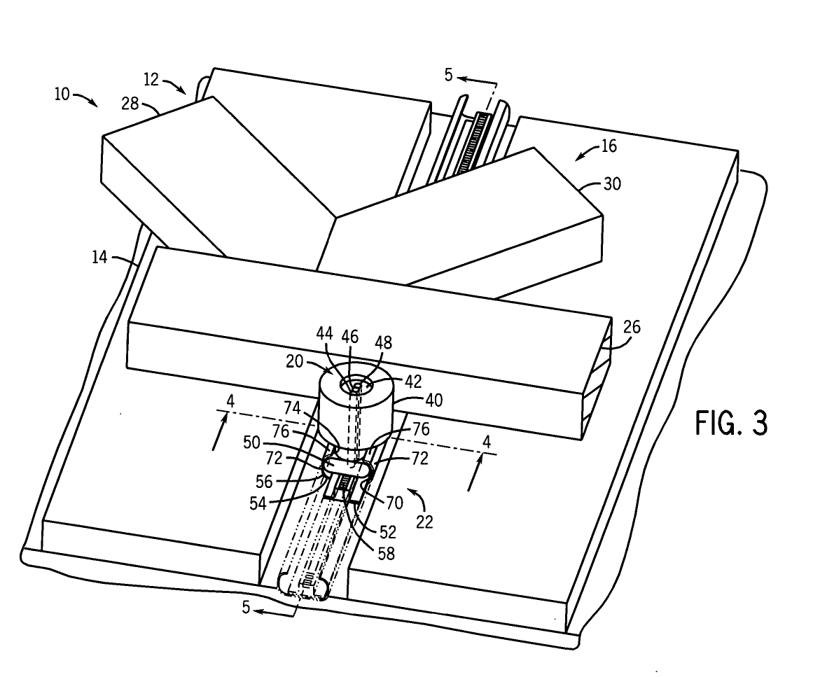

FIG. 3 is a partial perspective view of the light array gantry table 12 as illustrated in FIGS. 1 and 2, further illustrating details of the light transmitting puck 20 and the LED lined C-shaped channel 22 in accordance with certain embodiments of the present technique. As illustrated, the light transmitting puck 20 includes an outer annular structure or cylindrical plank engagement member 40 disposed about a central structure 42 having light pipes 44, 46, and 48. For example, the cylindrical plank engagement member 40 may have the shape of a wheel, ring, or disc, which is either fixed or rotatable relative to the central structure 42. Accordingly, one or more bearing assemblies may be disposed between the cylindrical plank engagement member 40 and the central structure 42. In other embodiments, the member 40 may have a square, triangular, spherical, semi-spherical, or other geometry. For example, a triangular geometry may be particularly advantageous at an angled joint between planks. The puck 20 also may be replaced with a variety of other truss jigging mechanisms, wherein light pipes or other light transmission mechanisms are incorporated into (or integral) with the body of the truss jigging mechanism. For example, the upper body or visible head portion of the truss jigging mechanism may be illuminable.

The central structure 42 extends through the outer annular structure 40 to an enlarged head or boss portion 50, which is slidingly movable and interlockable within the LED lined C-shaped channel 22. In other embodiments, the C-shaped channels 22 may be replaced with U-shaped channels, rectangular channels, or other linear positioning mechanisms for the pucks 20. In the illustrated embodiment, the LED lined C-shaped channel 22 includes a light array strip 52 disposed lengthwise along a base 54 of a C-shaped channel structure 56. Specifically, the illustrated light array strip 52 includes one or more sections disposed one after the other lengthwise along the C-shaped channel structure 56. For example, the light array strip 52 may include one or more sections of closely positioned LEDs 58, which are electrically and communicatively coupled to the computer system 34 via the control unit 36 as discussed above with reference to FIG. 2. In certain embodiments, the LEDs 58 may be arranged in blocks of one or more LEDs, e.g., 2, 3, 4, 5, 10, 15, 20, or 25. In this manner, inoperable or damaged LEDs 58 can be quickly and inexpensively replaced without significant interruptions in the truss fabrication process.

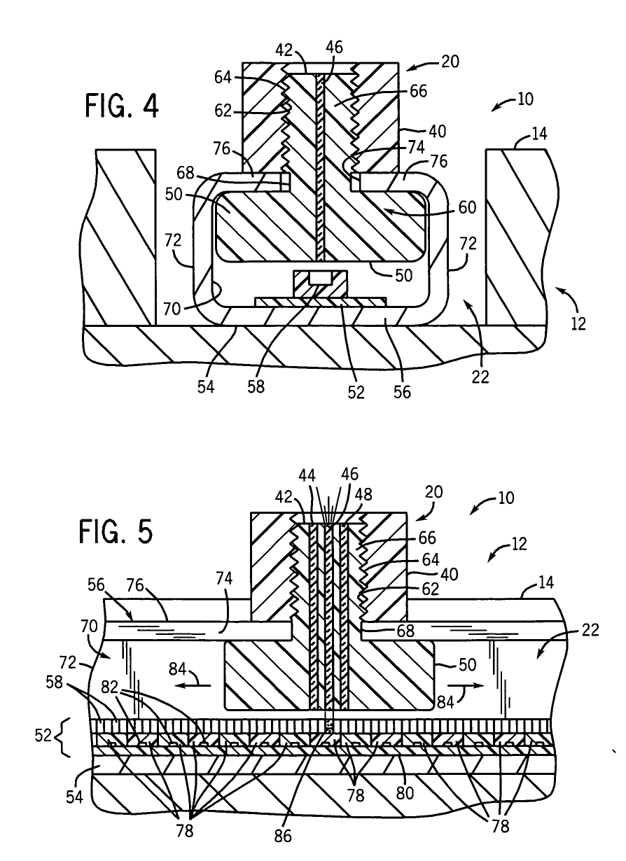

FIG. 4 is a cross-sectional end view of the light transmitting puck 20 engaged with the LED lined C-shaped channel 22 as illustrated in FIG. 3, further illustrating an interlocking mechanism 60 between the puck 20 and the channel 22 in accordance with embodiments of the present technique. As illustrated, the outer annular structure 40 of the light transmitting puck 20 includes internal threads 62 engaged with external threads 64 of a threaded top portion 66 of the central structure 42. For example, the internal and external threads 62 and 64 may extend along a generally helical pattern relative to a cylindrical geometry. The central structure 42 also includes a smooth or non-threaded intermediate portion 68 between the boss portion 50 and the threaded top portion 66. In the illustrated embodiment, the light transmitting puck 20 may be interlocked with the LED lined C-shaped channel 22 by inserting the central structure 42 laterally into an open end of the channel 22 and then threadingly tightening the outer annular structure 40 onto the threaded top portion 66.

As illustrated in FIG. 4, the C-shaped channel structure 56 includes an enlarged passage or channel 70 having sides 72 extending upwardly from the base 54. The C-shaped channel structure 56 also includes a reduced passage or narrow groove 74 between opposite upper lips 76, which extend inwardly from the opposite sides 72 of the C-shaped channel structure 56. In other words, the passage or groove 74 has a relatively smaller width than the passage or channel 70, such that the C-shaped channel structure 56 has a crosswise dimensional variation from the top to bottom of the channel 22. The crosswise dimensional variation of the C-shaped channel structure 56 enables the channel 22 to retain the boss portion 50 of the central structure 42 (and thus the puck 20) vertically relative to the table 12, while the constant lengthwise dimensions of the C-shaped channel structure 56 enable the light transmitting puck 20 to move horizontally lengthwise along the channel 22. In certain embodiments, the outer width of the boss portion 50 is closely fit with the inner width of the enlarged passage or channels 70, and the outer width of the smooth or non-threaded intermediate portion 68 is closely fit with the inner width between the opposite upper lips 76. In this manner, the close dimensional interface between these components facilitates smooth and stable movement of the light transmitting puck 20 lengthwise along the LED lined C-shaped channel 22.

The orientation and spacing between the light pipes 44, 46, and 48 and the LEDs 58 also may be selected to improve the accuracy and performance of the light array jigging system 18. As further illustrated in FIG. 4, the light pipe 46 extends vertically lengthwise through the central structure 42 in alignment with the LEDs 58 and the light array strip 52. Similarly, the light pipes 44 and 48 extend vertically lengthwise through the central structure 42 in alignment with the LEDs 58 and the light array strip 52. Moreover, the bottoms of the boss portion 50 and the light pipes 44, 46, and 48 are closely spaced above the LEDs 58 to facilitate efficient and accurate illumination of the light pipe 46. In some embodiments, the bottom of the boss portion 50 may include a central recess, groove, or channel that extends over and around the light array strip 50. In this manner, the light may be further focused toward the appropriate light pipe 44, 46, or 48.

FIG. 5 is a lengthwise cross-sectional side view of the light array gantry table 12 as illustrated in FIG. 3, further illustrating the light pipes 44, 46, and 48 of the light transmitting puck 20 in relation to LEDs 58 disposed in multiple sections or blocks 78 of the light array strip 52 in accordance with certain embodiments of the present technique. In the illustrated embodiment, each of the LED portions or blocks 78 includes four LEDs 58. However, as mentioned above, the LED blocks 78 may include any number of LEDs 58 (e.g., any integer from 1 to 100) in various embodiments of the present technique. The LED blocks 78 facilitate quick and easy installation, removal, and replacement of defective or inoperable LEDs 58 without affecting the calibration or accuracy of the overall jigging system 18. In other words, if a user removes one of the blocks 78 for servicing or replacement, then the remaining LED blocks 78 stay in a fixed position within the channels 22. This advantageously maintains the positional interrelationship between the LEDs 58 on the table 12.

The illustrated LED blocks 78 are coupled to an interconnecting base portion or strip 80 via connectors 82. For example, the connectors 82 may include pin and socket connectors, card edge and socket connectors, zero insertion force (ZIF) connectors, and other electrical connectors. The connectors 82 also may include mechanical fasteners, such as threaded fasteners, latches, snap-fit mechanisms, or various tool-free fasteners.

The interconnecting base portion or strip 80 may include one or more power and communication lines/wires leading to the control unit 36, which in turn is communicatively coupled to the computer system 34 as discussed above with reference to FIG. 2. In certain embodiments, the power and communication lines may be common to all of the LEDs 58 in a particular light array strip 52. Thus, the desired LEDs 58 may be identified by a unique identifier and appropriate circuitry. In certain embodiments, the interconnecting base portion or strip 80 also may include a plurality of modular sections to facilitate quick and easy installation or retrofitting of the light array strip 52 to a new or pre-existing gantry table 12. For example, the interconnecting base portion or strip 80 may have modular sections supporting one, two, three, or more of the LED blocks 78. The modular sections of the strip 80 may be interconnected at the lengthwise ends or edges via suitable electrical connectors and/or mechanical fasteners, such as those described above with reference to the LED blocks 78. In view of the modularity of the light array strip 52, a user can quickly and inexpensively remove and replace a damaged LED 58 via one of the LED blocks 78.

As indicated by arrows 84 in FIG. 5, the boss portion 50 of the light transmitting puck 20 can move lengthwise along the C-shaped channel structure 56 below the opposite upper lips 76. In operation, the computer system 34 commands the control unit 36 to illuminate one or more of the LEDs 58 along the light array strip 52, such that the light transmitting puck 20 can be positioned at the appropriate jigging point along the LED lined C-shaped channel 22. For example, one of the LEDs 58 may be illuminated at a jigging point 86. As a user moves the light transmitting puck along the LED lined C-shaped channel 22, the illuminated LED 58 at the jigging point 86 causes the light pipes 44, 46, and 48 to become illuminated one after the other. In certain embodiments, the light pipes 44, 46, and 48 have different colors, such as red, green, yellow, blue, and so forth. For example, the center light pipe 46 may be red, while the adjacent or outer light pipes 44 and 48 may be yellow or another color. As the puck 20 approaches the illuminated LED 58 at the jigging point 86, one of the outer light pipes 44 or 48 becomes illuminated to indicate that the jigging point 86 is relatively close to a centered position below the puck 20. Upon reaching a centered position with the jigging point 86, the central light pipe 46 become illuminated by the illuminated LED 58 at the jigging point 86. Accordingly, this series of different colored light pipes 44, 46, and 48 facilitates the proper positioning of the light transmitting puck 20 relative to the jigging point 86 identified by the illuminated LED 58. In other embodiments, other numbers, colors, and configurations of light pipes may be used to facilitate the proper positioning of the light transmitting puck 20 relative to the illuminated LED 58 at the jigging point 86.

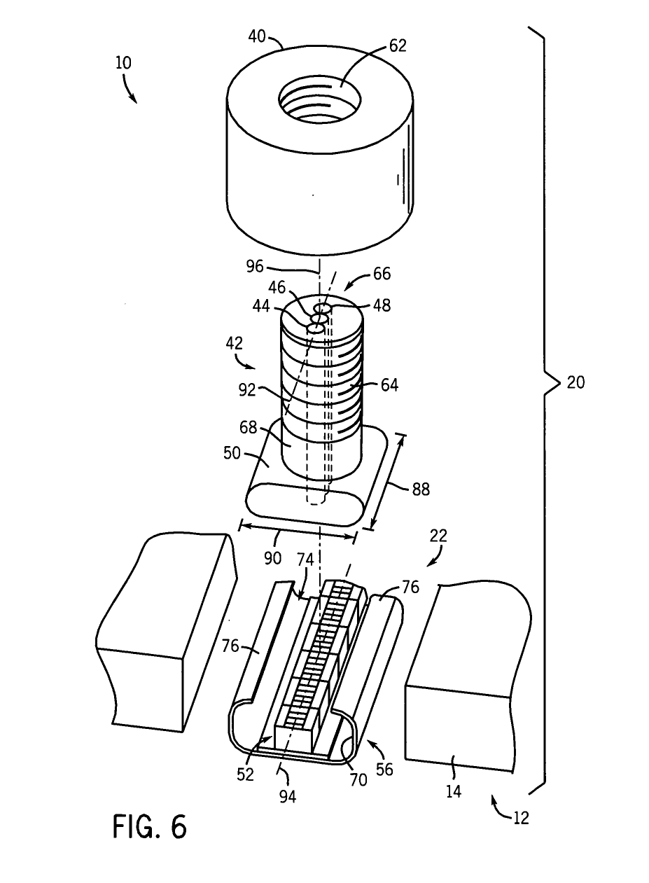

FIG. 6 is a partial exploded perspective view of the light array gantry table 12 as illustrated in FIG. 3, further illustrating the interconnections between the light transmitting puck 20 and the LED lined C-shaped channel 22 in accordance with certain embodiments of the present technique. As illustrated, the boss portion 50 of the central structure 42 has a length 88 that is substantially greater than a width 90, wherein the light pipes 44, 46, and 48 are aligned lengthwise along a longitudinal axis 92 of the boss portion 50. In view of these different dimensions 88 and 90, the boss portion 50 is generally movable or slidable lengthwise along a longitudinal axis 94 of the LED lined C-shaped channel 22 without substantial rotation about a central vertical axis 96 of the central structure 42. In this manner, the series of light pipes 44, 46, and 48 remain continuously aligned lengthwise with the LEDs 58 and the light array strip 52 of the LED lined C-shaped channel 22. In an alternative embodiment, the light pipes 44 and 48 may be replaced with one or more tubular or annular shaped light transmitting member disposed concentrically about the central light pipe 46. In this alternative embodiment, the boss portion 50 may have a cylindrical shape that permits rotation of the entire puck 20 about the vertical axis 96 relative to the channel 22, and the symmetrical configuration of the light pipe 46 and annular shaped light transmitting members enables light transmission from the LEDs 58 through the puck 20 despite the rotational position. Other shapes and configurations are also within the scope of the present technique.

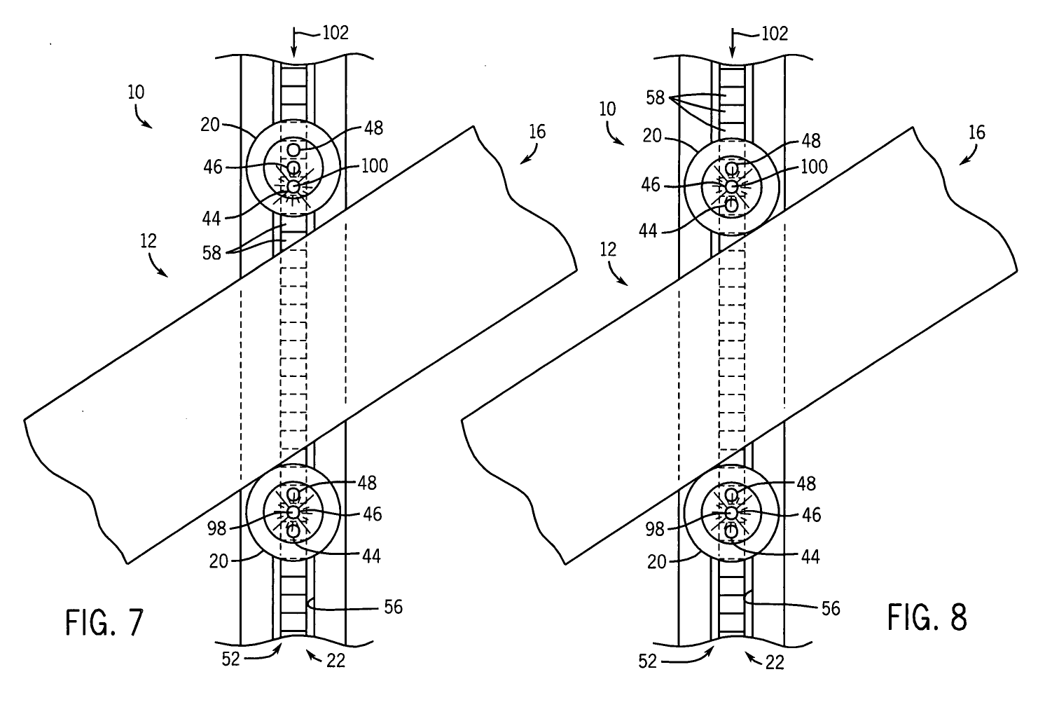

FIGS. 7 and 8 are diagrammatical top views of an exemplary embodiment of the light array gantry table 12 as illustrated in FIGS. 1-6, further illustrating a pair of the light transmitting pucks 20 disposed about a portion of the truss assembly 16 at jigging points 98 and 100 along the light array strip 52 in the LED lined C-shaped channel 22. As illustrated in FIG. 7, the lower light transmitting puck 20 is substantially centered over the jigging point 98 illuminated by one of the LEDs 58 in the light array strip 52. Specifically, the central light pipe 46 is substantially centered above the jigging point 98 identified by the illuminated LED 58, such that light from the LED 58 is transmitted through the central light pipe 46 to a viewable location at the top of the light transmitting puck 20. Again, the central light pipe 46 may be illuminated in a different color, such as red, relative to the outer light pipes 44 and 48. On the upper side of the truss assembly 16, FIG. 7 illustrates the light transmitting puck 20 off-center relative to the jigging point 100 identified by the illuminated LED 58 in the light array strip 52. Specifically, the lower light pipe 44 is disposed above the illuminated LED 58 at the jigging point 100, such that light is transmitted though the light pipe 44 to a viewable location at the top of the light transmitting puck 20. In certain embodiments as discussed above, the off center light pipe 44 emits a yellow color or another color different from the central light pipe 46. In this manner, the user is aware that the light transmitting puck 20 is near but not centered with the jigging point 100 identified by the illuminated LED 58. Accordingly, the user is notified to continue moving the light transmitting puck 20 in a downward direction as indicated by arrow 102.

Upon reaching a centered position over the jigging point 100 identified by the illuminated LED 58, the central light pipe 46 of the upper light transmitting puck 20 becomes illuminated with an appropriate color, e.g., red. FIG. 8 illustrates the upper light transmitting puck 20 disposed in a centered position over the upper jigging point 100 as indicated by the illuminated LED 58. In this manner, the light transmitting puck 20 cooperates with the LED lined C-shaped channel 22 to enable a user to quickly and easily set the desired jigging points for a particular truss assembly 16. Upon reaching the appropriate jigging point, e.g., points 98 and 100, the light transmitting pucks 20 can be secured to the C-shaped channel 56 by threadingly tightening the outer annular structure 40 relative to the central structure 42 of-the puck 20. In other embodiments, the light transmitting puck 20 may include a variety of other fastening mechanisms, such as threaded bolts, snap-fit mechanisms, latches, levering members, and so forth.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a truss fabrication table;
a plurality of lights disposed at coordinates on the truss fabrication table;
a light alignable puck disposed on the truss fabrication table, wherein the light alignable puck is configured to align with an illuminated one of the plurality of lights at selected coordinates.

2. The system of claim 1, wherein plurality of lights is disposed in a light array along a channel in the truss fabrication table.

3. The system of claim 2, wherein the light alignable puck is movable lengthwise along the channel.

4. The system of claim 3, wherein the channel comprises a C-shaped cross-section and the light alignable puck comprises a boss portion disposed in the C-shaped cross-section.

5. The system of claim 1, wherein the plurality of lights comprises a plurality of light emitting diodes.

6. The system of claim 1, comprising a plurality of light arrays including the plurality of lights, wherein the light arrays are oriented along the truss fabrication table in a generally parallel relationship to one another.

7. The system of claim 1, comprising a plurality of linear positioning mechanisms that movably support the light alignable puck, wherein the plurality of linear positioning mechanisms includes the plurality of light arrays.

8. The system of claim 1, wherein the light alignable puck comprises a light illuminable puck.

9. The system of claim 1, wherein the light alignable puck comprises a light pipe.

10. The system of claim 9, wherein the light pipe is disposed through a centerline of the light alignable puck.

11. The system of claim 1, wherein the light alignable puck comprises a plurality of light transmission mechanisms disposed at centered and off-center positions relative to a centerline of the light alignable puck.

12. The system of claim 11, wherein the plurality of light transmission mechanisms comprise light pipes having different colors.

13. A system, comprising:
a truss jigging member comprising a first light pipe, wherein the truss jigging member is configured to mount on a truss fabrication table along an array of lights.

14. The system of claim 13, wherein the first light pipe is substantially centered through the truss jigging member.

15. The system of claim 14, comprising second and third light pipes disposed through the truss jigging member on opposite sides of the first light pipe.

16. The system of claim 15, wherein the first light pipe comprises a first color and the second and third light pipes comprise second and third colors, wherein the first color is different from the second and third colors.

17. The system of claim 13, wherein the truss jigging member comprises a boss portion configured to interlock slidingly along a channel in the truss fabrication table.

18. The system of claim 13, wherein the first light pipe is configured to illuminate at a centered position of the truss jigging member relative to an illuminated one of the array of lights.

19. A method, comprising:
illuminating a light in a coordinate system of lights mounted directly on a truss fabrication table at a selected coordinate; and
aligning a puck to the selected coordinate via the illuminated light.

20. The method of claim 19, wherein illuminating the light comprises powering a selected light emitting diode in the coordinate system including a plurality of light emitting diodes mounted directly on the truss fabrication table.

21. The method of claim 19, wherein aligning the puck comprises transmitting light output from the light through a light transmitting member disposed in the puck.

22. The method of claim 19, wherein aligning the puck comprises transmitting light through multiple light pipes one after another as the puck approaches the selected coordinate.
